(19) United States
(12) Patent Application Publication
(10) Pub. No.: US 2013/0327971 A1
(43) Pub. Date: Dec. 12, 2013

(54) Ratcheting Handwheel for Compressed Gas Cylinders

(71) Applicant: Casidy Anise Anderson, Saint Louis Park, MN (US)

(72) Inventor: Casidy Anise Anderson, Saint Louis Park, MN (US)

(21) Appl. No.: 13/898,724

(22) Filed: May 21, 2013

Related U.S. Application Data
(60) Provisional application No. 61/656,684, filed on Jun. 7, 2012.

(51) Int. Cl. F16K 31/44

(52) U.S. Cl. CPC F16K 31/44
USPC 251/230

(57) ABSTRACT

A handwheel and method for use are disclosed. The handwheel including a body and a ratchet assembly disposed within the body, the ratchet assembly can include an interface that connects the ratchet assembly to a valve stem assembly of a compressed gas cylinder, the handwheel can include a chain or tether that secures the handwheel to the gas cylinder.

### RELATED APPLICATIONS

This application claims priority to U.S. Provisional Application Ser. No. 61/656,684 entitled Ratcheting Handwheel for Compressed Gas Cylinders, filed Jun. 7, 2012, which is incorporated herein by reference in its entirety.

### FIELD OF THE INVENTION

The subject matter of the specification is generally directed to openers for compressed gas cylinders.

### BACKGROUND

Compressed gas cylinders are used in a number of settings, such as fire rescue and resuscitation. In those circumstances, the compressed cylinders can be filled with oxygen to be provided to those in need.

Because the compressed gas cylinders are transported in emergency response vehicles (e.g., an ambulance or fire truck), typically, the compress gas cylinder has a removable handwheel to make the compressed gas cylinder more compact for transport. The removable handwheel can be used to manually open a valve on the compressed gas cylinder. However, to prevent the handwheel from being separated from compressed gas cylinder the handwheel is usually tethered to the compressed gas cylinder vis-à-vis a chain. But when turning the handwheel, there is a high likelihood that the chain will be entangled in the valve assembly. In some situations, the entangled chain may break, which increases the risk of losing the handwheel.

### SUMMARY

In general, one aspect of the subject matter described in this specification can be embodied in a handwheel including a body and a ratchet assembly disposed within the body, the ratchet assembly can include an interface that connects the ratchet assembly to a valve stem assembly of a compressed gas cylinder.

Another aspect of the subject matter described in this specification can be embodied in a method for opening a compressed gas cylinder, the method including the steps of connecting a ratchet assembly disposed in a body of a handwheel to a valve stem of the compressed gas cylinder, wherein an attachment mechanism tethers the handwheel to the compressed gas cylinder and turning the body of the handwheel in a manner that engages the ratchet assembly to open the valve stem.

These and other embodiments can each optionally include one or more of the following features. The body can be substantially circular. The ratchet assembly further includes a geared unit and a switching assembly. The interface can be a female socket that connects to a male socket of the valve stem assembly. The body further includes an attachment mechanism that tethers the body to the compressed gas cylinder. The attachment mechanism can tether the body to the valve stem of the compressed gas cylinder. The method can further include turning the body of the handwheel such that the attachment mechanism remains free from entanglement.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1B show different views of an example handwheel for opening a compressed gas cylinder, according to a particular embodiment.

FIG. 2 shows an example system including the handwheel and the compressed gas cylinder, according to a particular embodiment.

FIG. 3 is a flowchart showing an example method for opening a compressed gas cylinder.

Like reference numbers and designations in the various drawings indicate like elements.

### DETAILED DESCRIPTION

The present disclosure relates, in some embodiments, to a device for opening compressed gas cylinders. That is, in some embodiments, a handwheel device includes a ratchet assembly that can be used to open a compressed gas cylinder. In some uses of the handwheel, a compressed gas cylinder can be opened by those with limited ranges of motion, due to the operation of the ratchet assembly. In addition, according to particular embodiments, because the ratchet assembly can allow an operator to open the compressed gas cylinder using partial revolutions of the handwheel, a tether that may connect the handwheel and the compress gas cylinder can be maintained free from entanglement, preventing the tether from breaking and preventing the handwheel from otherwise becoming inoperative due to entanglement.

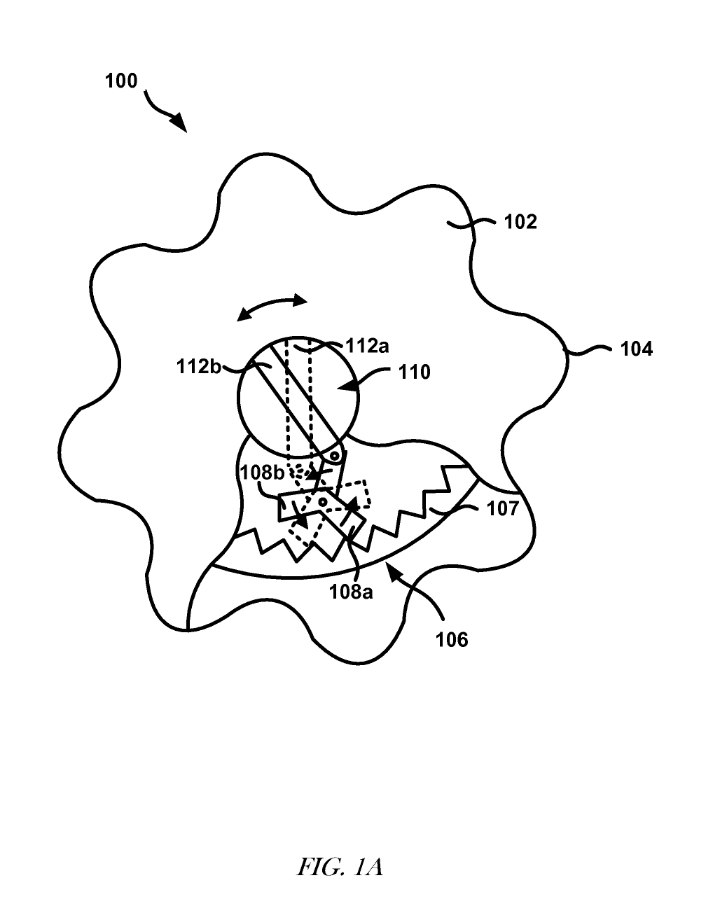

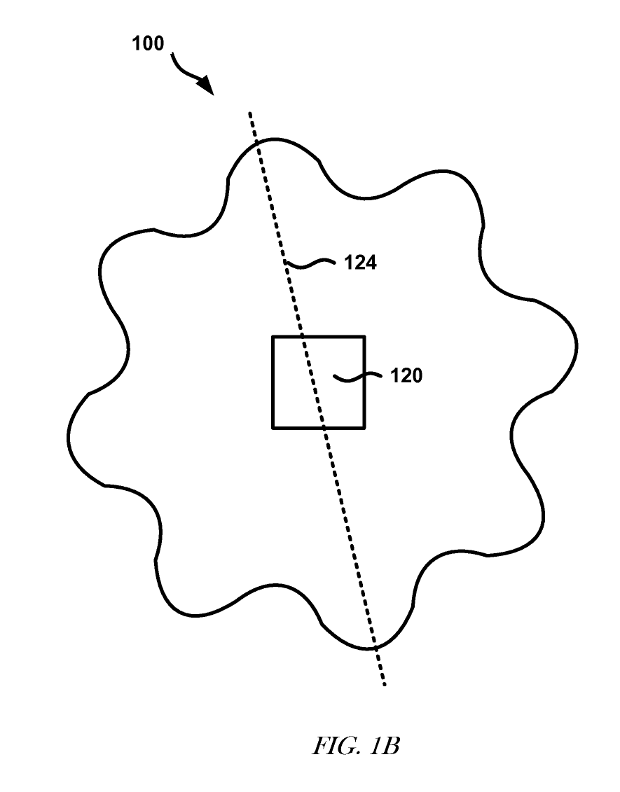

FIGS. 1A-1B show different views of an example handwheel 100 for opening a compressed gas cylinder, according to a particular embodiment. The handwheel 100 includes a body 102, a gripping portion 104, a ratchet assembly 106, a selection element 110, and an engagement element 120.

In reference to FIG. 1A, the handwheel 100 is shown from a top-down view, a portion of the handwheel 100 being cut-away to show the internal ratchet assembly 106. The handwheel body 102 is a central mass and can be constructed from a variety of traditional polymers, such as plastic or rubber, or can be constructed from metal or other materials according to particular embodiments. In still other embodiments, a combination of materials may be used. According to one or more embodiments, the handwheel body 102 is substantially circular, although the handwheel body 102 can be formed into different shapes according to particular embodiments. The handwheel body 102 also includes the gripping portion 104 disposed thereon, the ratchet assembly 106 disposed therein, the selection element 110, and the engagement element 120.

According to particular embodiments, the gripping portion 104 extends along the surface of the handwheel body 102. For example, in some embodiments, the gripping portion 104 extends along the circumference of the handwheel body 102 so that a user can operate the handwheel body 102 by gripping the gripping portion 104 with their fingers and or palm. In some embodiments, the gripping portion 104 can include a surface texture for gripping. For example, the gripping portion 104 can be a raised surface of the handwheel body 102, a dimpled surface of the handwheel body 102, a combination of these, or include some other surface texture. In other embodiments, the gripping portion 104 can be grooves or other physical deformities manufactured in the handwheel body 102 allowing a human operator of the handwheel 100 an ability to grip the handwheel 100 in the operator's hand. As such the gripping portion 104 allows the operator of the handwheel 100 to impart rotational force on the handwheel body 102 without encountering substantial slippage of the operator's hand from the handwheel body 102.

The ratchet assembly 106 can be a traditional ratchet system and can be disposed within the handwheel body 102. For example, the ratchet assembly may contain a gear 107 with one or more pawls (or levers) 108a and 108b that are typically spring-loaded. Depending on the position of the pawls 108a and 108b, the gear 107 can move in only one of a counter-clockwise or a clockwise direction. For example, if pawl 108a engages the gear 107, the gear can rotate in a clockwise direction without being impinged by the pawl 108a. Conversely, for example, if pawl 108b engages the gear 107, the gear 107 can rotate in a counter-clockwise direction without being impinged by the pawl 108b. That is, as the gear rotates, the pawls 108a and 108b allow movement in one predetermined direction only. The gear 107 can have a plurality of teeth of which the pawls 108a and 108b can engage. In the depicted example, the teeth are in the interior face of the gear 107. It should be appreciated, however, that the teeth can also be placed in the exterior face of the gear 107, according to particular embodiments. In such embodiments, the pawls 108a and 108b can interact with the teeth in substantially the same way as described above, although it should be understood that the positioning of the pawls 108a and 108b can be such that the pawls 108a and 108b engage the exterior face of the gear 107.

The selection element 110 can be accessible from the exterior of the handwheel body 102. For example, the selection element 110 can be a surface feature of the handwheel body 102. The selection element 110 can be any element that can be placed in a number of different states (e.g., a switch, button, or other toggleable apparatus). These different states can be used to selectively determine the behavior of the ratchet assembly 106.

For example, the selection element 110 can be operably connected to the ratchet assembly 106 to allow an operator of the handwheel 100 to select the behavior of the ratchet assembly 106. That is, the selection element 110 can be used to select the rotational direction in which the gear 107 of the ratchet assembly 106 moves. For example, the selection element 110 can be used to select which of the pawls 108a and 108b engages the gear 107 and therefore in which direction the gear 107 can rotated without obstruction.

In some embodiments, the selection element 110 can be placed in at least two different orientations (as illustrated by example orientations 112a and 112b) that an operator of the handwheel 100 can use to select the behavior of a ratchet assembly 106 housed within the handwheel body 102. For example, if the selection element 110 is oriented in a first position (such as the orientation 112b), a first pawl 108a or 108b may engage the gear 107 when the handwheel 100 is rotated in a generally clockwise direction. When the pawl 108a or 108b engages the gear 107, the pawl 108a or 108b effectively allows the gear 107 to move in one direction and prevents the gear 107 to move in the opposite direction (by acting as a physical barrier to the prevented motion).

Accordingly, if the selection element 110 is oriented in a second position (such as orientation 112a), the first pawl 108a may be disengaged and a second pawl 108b may engage the gear 107 of the ratchet assembly 106 when the handwheel 100 is rotated in a generally counter-clockwise direction. It should be understood that in some embodiments the switch positioned and ratchet behavior can be different. For example, if the switch 110 is oriented in the second orientation 112a, the second pawl 108b may be disengaged and the first pawl 108a may engage the gear 107 of the ratchet assembly 106 when the handwheel 100 is rotated in a generally counter-clockwise direction.

In some embodiments, the selection element 110 can be a push-button, latch, or other toggleable apparatus. For example, a push-button can be spring-loaded, such that when placed in the down position it operates as if the selection element 110 were positioned according to orientation 112a. Similarly, when the push-button is in the up position, the mechanism operates as if the selection element 110 were position according to orientation 112b.

In reference to FIG. 1B, the handwheel 100 is shown from a bottom-up view. In the depicted example, the handwheel 100 includes the engagement element 120 (e.g., a male or female socket) that can be used to connect the handwheel 100 to a compressed gas cylinder. The engagement element 120 can be operably connected to the handwheel body 102 via the ratchet assembly 106. For example, the engagement element 120 can be an exposed portion of the ratchet assembly 106. The engagement element 120 can be at least partially disposed within the handwheel body 102, according to particular embodiments.

In the depicted example, the engagement element 120 is a female socket. That is, the engagement element 120 can be a recessed opening in which a corresponding other protrusion (e.g., a male socket) can be inserted. In some embodiments, the engagement element 120 is pre-configured to interface with a specific type of corresponding connector. For example, the engagement element 120 can be a square-shaped female socket configured to receive a corresponding square-shaped male socket included in the compressed gas cylinder. In operation, the general arrangement of the handwheel body 102, the ratchet assembly 106, and the engagement element 120 can allow for rotational motion in the handwheel body 102 but not in the engagement element 120.

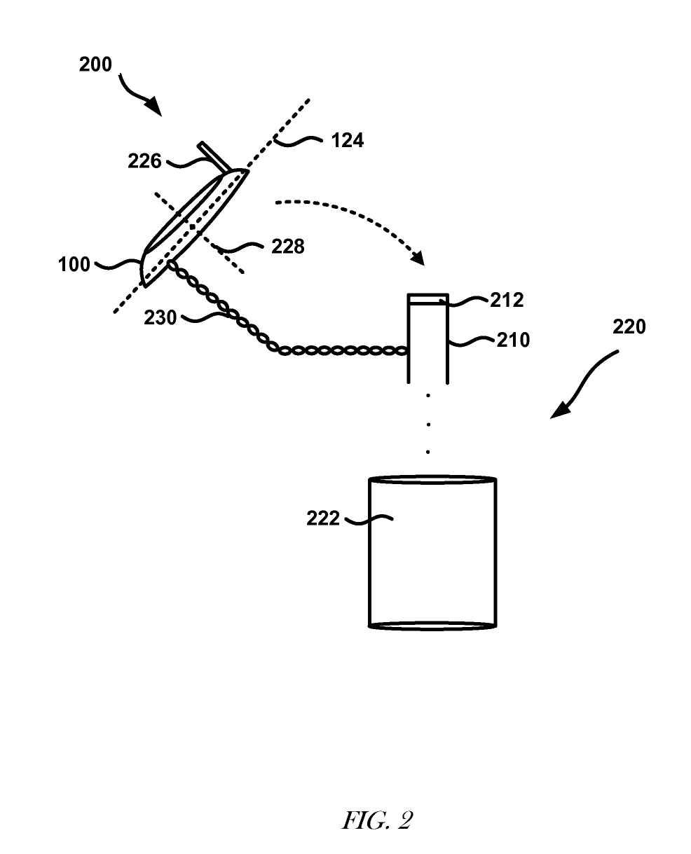

FIG. 2 shows an example system 200 that includes a handwheel 100 to open a compressed gas cylinder 220. The compressed gas cylinder 220 can be any typical compressed container. That is, the compressed gas cylinder 220 can be any appropriate receptacle for storing and releasing compressed gasses including oxygen, nitrogen, helium, and hydrogen, to name a few examples. In addition, depending on the gas contained within the compressed gas cylinder 220, the shape of the compressed gas cylinder 220 may differ. For example, portable compressed cylinders may include wheels and be of a generally cylindrical shape, while some types of propane cylinders for use in grills and other personal applications may be more spherical in shape.

In the depicted example, the compressed gas cylinder 220 also includes a gas valve 210, a compressed gas container 222 (e.g., a tank or other housing) and a tether 230. The compressed gas container 222 can be made of different materials according to particular embodiments including steel and aluminum and can be used to store the compressed gas. In particular embodiments, the handwheel 100 is configured to be removable. That is, to allow the compressed gas cylinder 220 to be more portable, the handwheel 100 can be removed for storage. For example, in emergency response vehicles, where spacing may be an issue, the handwheel 100 can be removed during storage. Moreover, removing the handwheel 100 from the gas valve 210 during transport helps to prevent damage to the gas valve 210 during transport of the compressed gas cylinder 220.

In embodiments where the handwheel 100 is configured to be removable, the tether 230 can be used to attach the handwheel 100 to the gas valve 210 to ensure that the handwheel 100 is not lost or misplaced during transport. The tether 230 can be a chain such as a pen-chain, or can be some other attachment mechanism including a tie, string, cord, or other mechanism to attach the handwheel 100 to the gas valve 210. In the depicted example, the tether 230 is affixed to the gas valve 210 of the compressed gas cylinder 220, although it should be understood that the tether 230 can be alternatively be affixed to other parts of the compressed gas cylinder 220 including but not limited to the compressed gas container 222.

The gas valve 210 can be in a fully opened state, a fully closed state, or in a partially opened state. In some embodiments, the gas valve 210 can be configured to be opened and closed by the handwheel 100. For example, as shown, the gas valve 210 includes a socket 212 that can interface with the handwheel 100. That is, the socket 212 can be inserted into engagement element 120 disposed in the handwheel body 102. In the depicted example, the socket 212 is shown as a square male socket, although the gas valve 210 may include different connective elements including a circular male socket, female sockets, or other elements. That is, the socket 212 can be of various shapes and sizes according to particular embodiments.

Once connected, the handwheel 100 can be turned to manipulate the gas valve 210. In essence, the gas valve 210 acts as a stopper for the compressed gas container 222. That is, when the gas valve 210 is in a fully or partially opened state the contents of the compressed gas container 222 (e.g., compressed oxygen or other gases), can escape the compressed gas container 222. These gases can be used for a variety of purposes, including providing oxygen for firefighters, providing oxygen for those on an oxygen regimen, and those requiring emergency aid (e.g., at the site of crash or other accident). Likewise, if the gas valve 210 is in the closed state, the gas contained within the compressed gas container 222 is substantially prevented from leaving the compressed gas container 222. Similarly, if the gas valve 210 is in the partially open state, some gas may be allowed to escape from compressed gas container 222.

As an operator turns or rotates the handwheel 100 in a first direction to tighten or loosen the gas valve 210, one pawl 108a is wedged into the gear 107 (while the other pawl 108b does not generally engage the gear), preventing the gear 107 from slipping as the operator continues to tighten or loosen the object. When the operator turns or rotates the handwheel 100 in a second direction, the operator may hear a clicking noise, and the pawl 108a may release the gear 107 so that the operator can continue to turn or rotate the ratchet assembly 106 in the second direction without substantially loosening the object. By employing a ratcheting mechanism, the handwheel 100 can be operated by those with limited ranges of motion and may be generally operated in a more efficient manner because the handwheel 100 can be operated without entangling the tether 230.

In the depicted example, as stated previously, the handwheel 100 can be substantially circular and removable. But the handwheel 100 can also be permanently affixed to the gas valve 210, according to particular embodiments. The handwheel 100 can be square, tee-shaped, polygon-shaped, or any other shape. The handwheel 100 can include a removable or permanently affixed handle 226. The handle 226 allows a user to apply more torque to the handwheel body 102 so as to allow a user to apply more rotational force to the socket 212. In some embodiments the handwheel 100 can be configured to toggle from a perpendicular to a horizontal position to act as a lever, according to particular embodiments.

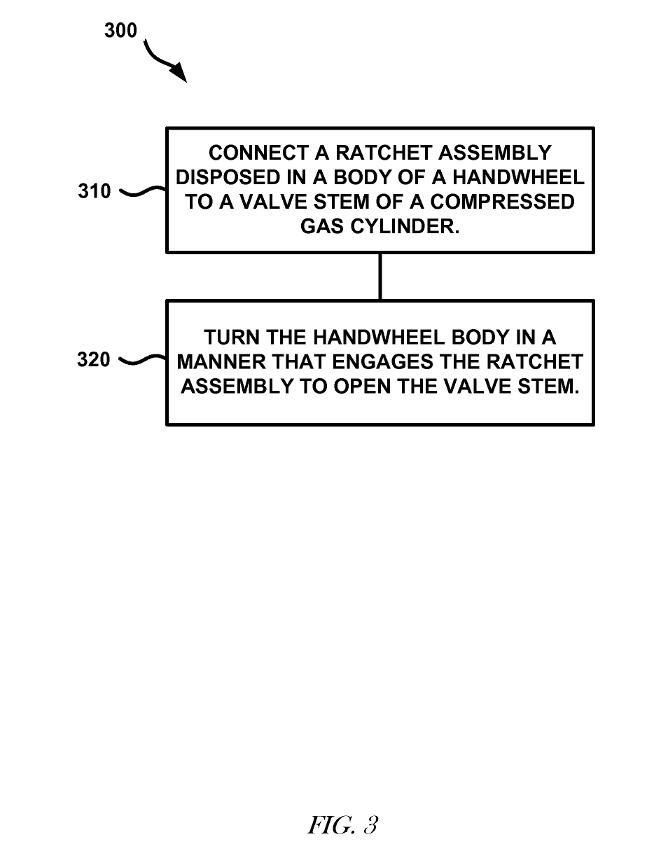

FIG. 3 is a flow chart showing an example method 300 for opening a compressed gas cylinder. For convenience, FIG. 3 is described in reference to an example configuration illustrated in FIGS. 1A-1B and 2, although it should be understood that method 300 can be performed using other configurations according to particular embodiments.

In operation 310, a ratchet assembly disposed in a body of a handwheel is connected to a valve stem of a compressed gas cylinder. For example, the engagement element 120 included in the handwheel body 102 can interface with the male socket 212 (e.g., by inserting the male socket 212 in the female socket 120) of the gas valve 210 included in the compressed gas cylinder 220 to connect the handwheel 100 to the compressed gas cylinder 220.

In operation 320, the handwheel body 102 is turned in a manner that engages the ratchet assembly to open the valve stem. For example, the selection element 110 can be placed in a first position such that when the handwheel body 102 is turned a plurality of times in a generally clock-wise direction, the gear 107 assembly included in the ratchet assembly 106 disposed with the handwheel 100 is engaged. In particular embodiments, this causes one of the pawls 108a in the gear assembly to allow the gear 107 to rotate in one direction, but prevents the gear 107 from moving in the other direction, as described in more detail above.

In some embodiments, turning the handwheel body 102 further includes maintaining a tether 230 or other attachment mechanism free from entanglement. For example, the handwheel 100 can be turned without substantially entangling the tether 230. That is, because the handwheel 100 can be partially rotated due to the use of the ratchet assembly 106 included in the handwheel 100, the handwheel 100 can be turned without being caught by the tether 230 affixed to the compressed gas cylinder 220.

It will be appreciated that while the operations 310-320 are shown in a flow chart and have been described in order, some or all of the operations may be performed in other orders or may be omitted. In addition, other operations may be performed, according to particular embodiments.

Thus, particular embodiments of the subject matter have been described. Other embodiments are within the scope of the following claims.

What is claimed:

1. An apparatus comprising:
a handwheel-shaped body with a diameter;
a ratchet assembly disposed within the body; and
wherein the ratchet assembly includes an interface that connects the ratchet assembly to a valve stem assembly of a compressed gas cylinder.

2. The apparatus of claim 1, wherein the body is substantially circular.

3. The apparatus of claim 1, wherein the ratchet assembly further comprises a geared unit and a switching assembly.

4. The apparatus of claim 1, wherein the interface is a female socket that connects to a male socket of the valve stem assembly.

5. The apparatus of claim 1, wherein the body further comprises an attachment mechanism that tethers the body to the compressed gas cylinder.

6. The apparatus of claim 5, wherein the attachment mechanism tethers the body to the valve stem of the compressed gas cylinder.

7. The apparatus of claim 6, wherein the body is removable from the valve stem.

8. The apparatus of claim 6, wherein the body is permanently affixed to the valve stem.

9. The apparatus of claim 1, wherein the interface is a male socket that connects to a female socket of the valve stem assembly.

10. A method for opening a compressed gas cylinder, the method comprising:
connecting a ratchet assembly disposed in a body of a handwheel to a valve stem of the compressed gas cylinder, wherein an attachment mechanism tethers the handwheel to the compressed gas cylinder; and
turning the body of the handwheel in a manner that engages the ratchet assembly to open the valve stem.

11. The method of claim 8, wherein turning the body of the handwheel includes maintaining the attachment mechanism free from entanglement.

12. A handwheel configured for use on a compressed gas cylinder, the handwheel comprising:
a body longitudinally disposed along a first axis, transversely extending along a second axis, and configured so that a user may grip the handwheel along a perimeter of the handwheel in a transverse plane perpendicular to the plane formed by the first axis and the second axis;
a ratchet assembly, the ratchet assembly including at least two pawls disposed within the body;
a selection mechanism configured to engage one of the at least two pawls so as to select which pawl engages a geared unit of the ratchet assembly; and
a female socket that connects the handwheel to a male socket on a valve stem assembly of the compressed gas cylinder.

13. The handwheel of claim 12, wherein the body is substantially circular.

14. The handwheel of claim 12, wherein a handle extends outward from the handwheel along an axis parallel to an axis transverse to the handwheel.

15. The handwheel of claim 12, wherein the body further comprises an attachment mechanism that tethers the body to the compressed gas cylinder.

16. The handwheel of claim 15, wherein the attachment mechanism tethers the body to the valve stem of the compressed gas cylinder.

17. The handwheel of claim 12, wherein the interface is a male socket that connects to a female socket of the valve stem assembly.

18. The handwheel of claim 16, wherein the body is permanently affixed to the valve stem.

19. The handwheel of claim 16, wherein the body is removable from the valve stem.
